(19) United States
(12) Patent Application Publication
(10) Pub. No.: US 2025/0165904 A1
(43) Pub. Date: May 22, 2025

(54) COLD CHAIN TEMPERATURE CONTROL OPTIMIZATION

(71) Applicant: International Business Machines Corporation, Armonk, NY (US)

(72) Inventors: Renjith Ramakrishnan, Kollam (IN); Suman Patra, KOLKATA (IN); Anfaal Banglail Ali, CHENNAI (IN); Tanooja Murugan, Velur (IN)

(21) Appl. No.: 18/514,027

(22) Filed: Nov. 20, 2023

(51) Int. Cl. G06Q 10/0832

(52) U.S. Cl. CPC G06Q 10/0832; G06Q 10/083

(57) ABSTRACT

A processor may receive a shipment request associated with a shipment. The processor may analyze the shipment request. The processor may generate one or more estimated metrics associated with the shipment based on the analyzing. The processor may apply an amount of thermal agent for the shipment to reach a final destination based on the one or more estimated metrics.

### BACKGROUND

The present disclosure relates generally to the field of cold chain management, and more specifically to cold chain temperature control optimization.

Cold chain logistics use various temperature control agents to retain the temperature requirements of perishable goods used in a shipment. Examples of temperature control agents include ice, dry ice, gel packs, and the like.

Accordingly, major logistics providers own facilities to generate and supply temperature control agents, such as dry ice, to meet the cold chain requirements from shippers. Dry ice is a chemical, solid CO₂, that is extensively used as a temperature control agent for transporting packages at frozen and/or ultra-frozen temperatures. When supplemental dry ice is added onto an in-transit shipment at intermediate locations, this is called re-icing. This is typically provided as an add-on service by various cold chain service providers. It is important to make sure enough dry ice is available at all facilities handling the cold chain packages to enable proper re-icing so these packages reach their destinations while retaining the prescribed temperature and humidity conditions.

In the current state, logistics providers use a lot of manual decision making along with non-standard tools/static rules across different facilities to provide icing and re-icing demands. Often an excess quantity of dry ice is carried in containers to mitigate the risk of impacting the goods and re-icing is done on a need-basis to maintain expected temperatures. This typically results in inconsistent and even inaccurate decisions leading to higher operational cost, damaged contents (e.g., if re-icing demand is not met), and/or customer dissatisfaction.

### SUMMARY

Embodiments of the present disclosure include a method, computer program product, and system for cold chain temperature control optimization. A processor may receive a shipment request associated with a shipment. The processor may analyze the shipment request. The processor may generate one or more estimated metrics associated with the shipment based on the analyzing. The processor may apply an amount of thermal agent for the shipment to reach a final destination based on the one or more estimated metrics.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram illustrating an embodiment of a computer system and the components thereof upon which embodiments described herein may be implemented in accordance with the present disclosure.

FIG. 2 illustrates a block diagram illustrating an extension of the computing system environment of FIG. 1, wherein the computer systems are configured to operate in a network environment (including a cloud environment) and perform methods described herein in accordance with the present disclosure.

FIG. 3 depicts a block diagram of an example system for cold chain temperature control optimization in accordance with aspects of the present disclosure.

FIG. 4 illustrates a block diagram of an example implementation of a system for cold chain temperature control optimization in accordance with aspects of the present disclosure.

FIG. 5 depicts a flowchart of an example method for cold chain temperature control optimization in accordance with aspects of the present disclosure.

FIG. 6 illustrates a flowchart of an example method for cold chain temperature control optimization in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of cold chain management, and more specifically to cold chain temperature control optimization. While the present disclosure is not necessarily limited to such applications, various aspects of the disclosure may be appreciated through a discussion of various examples using this context.

Cold chain logistics use various temperature control agents (which may also be referred to as thermal agents) to retain the temperature requirements of perishable goods used in a shipment. Examples of temperature control agents include ice, dry ice, gel packs, and the like. This disclosure aims to provide a cognitive solution (e.g., a method, system, and computer program product) to optimally estimate and forecast the production and/or procurement of thermal agents required by cold chain systems, structures, networks, and the like. For the scope of this disclosure, dry ice is used as a primary example and/or best mode of thermal agents, however the solution provided in this disclosure is applicable to any and all other temperature control agents.

Major logistics providers own facilities to generate and supply temperature control agents such as dry ice to meet the cold chain requirements from shippers. Dry ice is solid CO₂, a chemical that is extensively used as a temperature control agent for transporting packages at frozen and/or ultra-frozen temperatures. When supplemental dry ice is added on to an in-transit shipment at intermediate locations, it is called re-icing. Re-icing is typically provided as an add-on service by various cold chain service providers. For re-icing, it is important to make sure enough dry ice is available at all facilities handling cold chain packages such that these packages reach the destination while retaining the prescribed temperature and humidity conditions.

Currently, logistics providers use a lot of manual decision making along with non-standard tools and/or static rules across different facilities to provide icing and re-icing demands. Often an excess quantity of dry ice is carried in each container to mitigate the risk of impacting the goods and re-icing is done on an as-needed basis to maintain expected temperature(s). This typically results in inconsistent and/or inaccurate decisions leading to higher operational cost, damaged contents (e.g., if re-icing demand is not met), and/or customer dissatisfaction.

An additional consideration is that thermal agents, such as dry ice, may be hazardous chemicals with regulations on how much is allowed on a carrier, how much can be safely stored in a facility, and the like. Due to this reason, it is also important to not keep excessive quantities of a thermal agent at any given location/destination.

Further, if the procurement, production, and storage of a thermal agent (e.g., dry ice) is not optimized as per the above requirements, it may lead to operational challenges such as legal and cost implications.

This disclosure aims to solve the problem of optimally producing, storing, and applying said thermal agents in a cold chain system by devising a cognitive solution which centrally estimates and forecasts the optimal quantity of thermal agents while also considering the regulatory requirements and cost on storage and transit. The cognitive solution disclosed herein can further auto-calibrate the thermal agent estimation model using machine learning and/or feedback depending on the environmental and operational variations within an enterprise.

As such, before turning to the figures for an in-depth discussion of the solution disclosed herein, a general overview of the solution is provided. This disclosure proposes a system, method, and computer program product to centrally estimate and forecast an optimal quantity of thermal agent required at facilities handling cold chain packages of a logistics provider(s). The optimized estimate can be calculated for each shipment and be based on factors such as: re-icing capabilities at intermediate locations (e.g., secondary destinations) in transit, legal constraints, and/or temperature index of routes. A logistics provider thereby may not have to add excess amounts of thermal agent for the whole duration of the journey (e.g., to a final destination). This may reduce the overall shipment weight, the cost of shipment, and the risk of hazards and environmental impacts (e.g., due to leakage of a product in the shipment and/or the thermal agent).

Further, the estimated quantity of thermal agents for each shipment going through a cold chain facility may be aggregated and forecasted to optimally determine the production, procurement, and/or storage of thermal agents in each facility. Additionally, the solution provided herein may also reliably re-estimate the quantities required for a package and for a shipment facility (e.g., destination) based on any changes in logistics plans caused by external and/or internal shipping factors such as a route change. This may avoid excess generation of thermal agents in facilities. Another aspect of the solution is an auto-calibrated cognitive estimation engine that may self-correct the estimation model based on feedback about shipping processes regarding thermal quantity used versus the estimated thermal quantity necessary.

In some embodiments, the solution provided herein estimates and forecasts the optimal quantity of thermal agent(s) at the level of shipments as well as at the level of facilities (e.g., destinations) by considering current re-icing facilities available in a cold chain route during the estimation process. The solution may further automatically re-estimates the quantity of necessary thermal agent(s) when there is a change in one or more dependent parameters such as route, temperature index of the route or path, and the like, which may be a result of a change in one or more other parameters.

The solution may also automatically calibrate and/or correct the estimation model for thermal agent(s) based on feedback from error corrections during the shipment process of the products and/or objects. Further, the solution provided herein, in addition to providing the results of the estimation of the thermal agent(s), may incorporate operational cost considerations and factors related to environmental sustainability into route optimization decisions (e.g., which routes or paths to take to any destinations).

Before turning to the figures, it is noted that various aspects of the present disclosure are described by narrative text, flowcharts, block diagrams of computer systems, and/or block diagrams of the machine logic included in computer program product (CPP) embodiments. With respect to any flowcharts (depending upon the technology involved), the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices. The storage media may collectively include machine readable code corresponding to instructions and/or data for performing computer operations. A “storage device” may refer to any tangible hardware or device that can retain and store instructions for use by a computer processor. Without limitation, a computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits and/or lands formed in a major surface of a disc), or any suitable combination thereof. A computer-readable storage medium should not be construed as storage in the form of transitory signals per se such as radio waves or other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation or garbage collection, but this does not render the storage device transitory because the data is not transitory while it is stored.

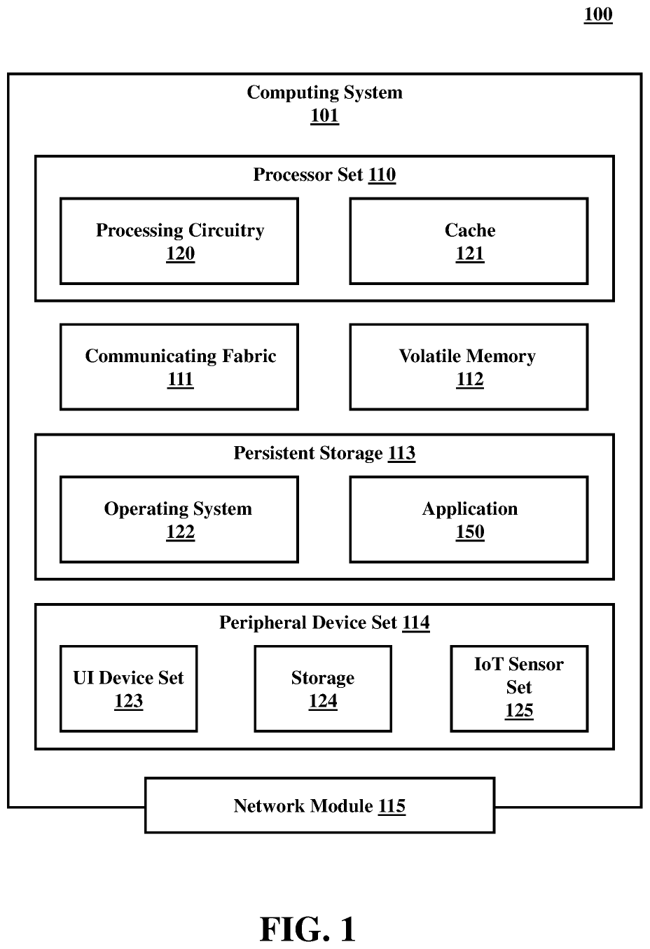

Referring now to FIG. 1, a block diagram is illustrated describing an embodiment of a computing system 101 within in a computing environment, which may be a simplified example of a computing device (e.g., a physical bare metal system and/or a virtual system) capable of performing the computing operations described herein. The computing system 101 may be representative of the one or more computing systems or devices implemented in accordance with the embodiments of the present disclosure and further described below in detail. FIG. 1 provides only an illustration of one implementation of a computing system 101 and does not imply any limitations regarding the environments in which different embodiments may be implemented. In general, the components illustrated in FIG. 1 may be representative of an electronic device, either physical or virtualized, capable of executing machine-readable program instructions.

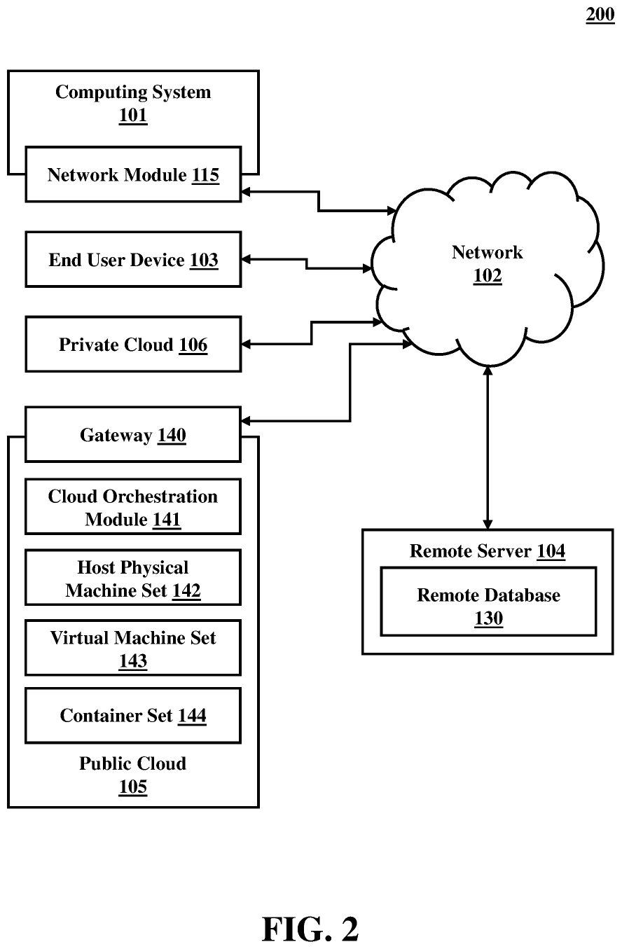

Embodiments of the computing system 101 may be, for example, a desktop computer, laptop computer, tablet computer, smart phone, smart watch or other wearable computer, mainframe computer, server, quantum computer, non-conventional computer system such as an autonomous vehicle or home appliance, or another form of computer or mobile device now known or to be developed in the future that is capable of running a program 150, accessing a network 102, or querying a database such as remote database 130. Performance of a computer-implemented method executed by a computing system 101 may be distributed among multiple computers and/or between multiple locations. The computing system 101 may be located as part of a cloud network even though it is not shown within a cloud in FIGS. 1-2. Moreover, the computing system 101 is not required to be in a cloud network except to any extent as may be affirmatively indicated.

A processor set 110 includes at least one computer processor of any type now known or to be developed in the future. Processing circuitry 120 may be distributed over multiple packages, for example, multiple coordinated integrated circuit chips. The processing circuitry 120 may implement multiple processor threads and/or multiple processor cores. A cache 121 may refer to memory that is located on the processor chip package(s) and/or may be used for data and/or code that may be available for rapid access by the threads or cores running on the processor set 110. Cache 121 memories may be organized into multiple levels depending upon relative proximity to the processing circuitry 120. Alternatively, some or all of the cache 121 of the processor set 110 may be located off chip. In some computing environments, the processor set 110 may be designed for working with qubits and performing quantum computing.

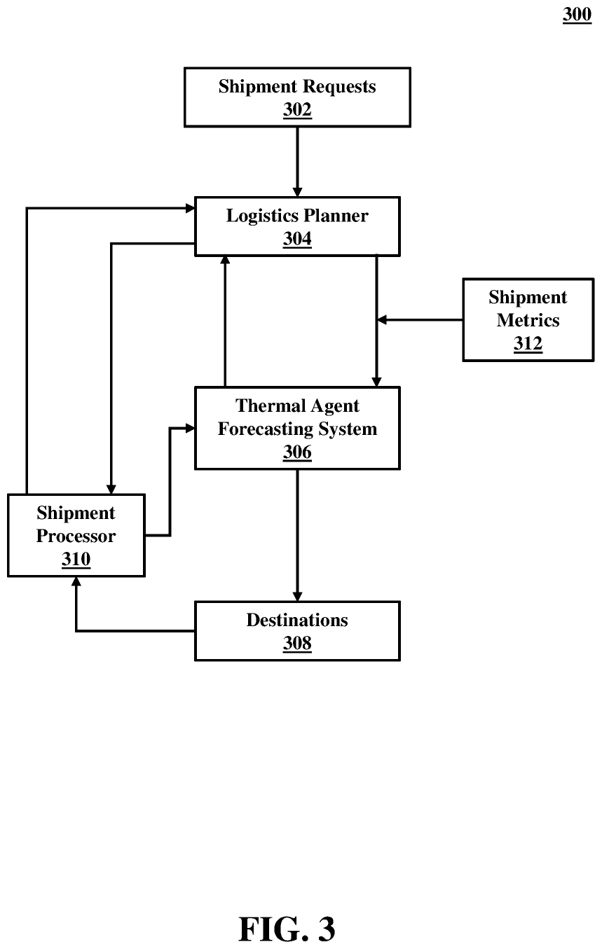

Computer readable program instructions may be loaded onto the computing system 101 to cause a series of operational steps to be performed by the processor set 110 of the computing system 101 and thereby implement a computer-implemented method. Execution of the instructions may instantiate the methods specified in the flowcharts and/or narrative descriptions of computer-implemented methods included in this specification (collectively referred to as “the inventive methods”). The computer readable program instructions may be stored in various types of computer readable storage media such as the cache 121 and the other storage media discussed herein. The program instructions, and associated data, may be accessed by the processor set 110 to control and/or direct performance of the inventive methods. In computing environments of FIGS. 1-2, at least some of the instructions for performing the inventive methods may be stored in the persistent storage 113, volatile memory 112, and/or cache 121 as application(s) 150 comprising one or more running processes, services, programs, and installed components thereof. For example, program instructions, processes, services, and installed components thereof may include the components and/or sub-components of the system 300 as shown in FIG. 3.

A communication fabric 111 may refer to signal conduction paths that may allow various components of computing system 101 to communicate with each other. For example, the communications fabric 111 may provide for electronic communication among the processor set 110, volatile memory 112, persistent storage 113, peripheral device set 114, and/or network module 115. The communication fabric 111 can be made of switches and/or electrically conductive paths such as the switches and electrically conductive paths that make up busses, bridges, physical input/output ports, and the like. Other types of signal communication paths may be used such as fiber optic communication paths and/or wireless communication paths.

The volatile memory 112 may refer to any type of volatile memory now known or to be developed in the future and may be characterized by random access; random access is not required unless affirmatively indicated. Examples include dynamic-type random access memory (RAM) or static-type RAM. In the computing system 101, the volatile memory 112 is located in a single package and can be internal to the computing system 101; alternatively, or additionally, the volatile memory 112 may be distributed over multiple packages and/or located externally with respect to the computing system 101. Application 150, along with any program(s), processes, services, and installed components thereof, described herein, may be stored in the volatile memory 112 and/or persistent storage 113 for execution and/or access by one or more of the respective processor sets 110 of the computing system 101.

Persistent storage 113 may be any form of non-volatile storage for computers that may be currently known or developed in the future. The non-volatility of this storage means the stored data may be maintained regardless of whether power is supplied to the computing system 101 and/or directly to the persistent storage 113. The persistent storage 113 may be a read-only memory (ROM); however, at least a portion of the persistent storage 113 may allow writing of data, deletion of data, and/or re-writing of data. Some forms of persistent storage 113 may include magnetic disks, solid-state storage devices, hard drives, flash-based memory, erasable read-only memories (EPROM), and/or semi-conductor storage devices. An operating system 122 may take several forms, such as various known proprietary operating systems or open-source Portable Operating System Interface-type operating systems that employ a kernel.

A peripheral device set 114 may include one or more peripheral devices connected to the computing system 101, for example, via an input/output (I/O interface). Data communication connections between the peripheral devices and the other components of the computing system 101 may be implemented using various methods, for example, through connections using Bluetooth, Near-Field Communication (NFC), wired connections or cables (such as universal serial bus (USB) type cables), insertion-type connections (for example, secure digital (SD) card), connections made though local area communication networks, and/or wide area networks such as the internet. In various embodiments, UI device set 123 may include components such as a display screen, speaker, microphone, wearable devices (such as goggles, headsets and smart watches), keyboard, mouse, printer, touchpad, game controllers, and/or haptic feedback devices. Storage 124 may include external storage (e.g., an external hard drive) or insertable storage (e.g., an SD card). Storage 124 may be persistent and/or volatile. In some embodiments, storage 124 may take the form of a quantum computing storage device for storing data in the form of qubits. In some embodiments, networks of computing systems 101 may utilize clustered computing and/or components acting as a single pool of seamless resources when accessed through a network by one or more computing systems 101, for example, a storage area network (SAN) that is shared by multiple, geographically distributed computer systems 101 or network-attached storage (NAS) applications. An IoT sensor set 125 may be made up of sensors that can be used in Internet-of-Things (IoT) applications; for example, a sensor may be a temperature sensor, motion sensor, infrared sensor, and/or any other type of known sensor type.

A network module 115 may include a collection of computer software, hardware, and/or firmware that allows the computing system 101 to communicate with other computer systems through a network 102 such as a LAN or WAN. The network module 115 may include hardware (e.g., modems or Wi-Fi signal transceivers), software (e.g., for packetizing and/or de-packetizing data for communication network transmission), and/or web browser software (e.g., for communicating data over the network). In some embodiments, network control functions and/or network forwarding functions of network module 115 may be performed on the same physical hardware device. In other embodiments (for example, embodiments that utilize software-defined networking (SDN)), control functions and forwarding functions of network module 115 may be performed on physically separate devices such that the control functions may manage several different network hardware devices. Computer readable program instructions for performing the inventive methods may typically be downloaded to the computing system 101 from an external computer and/or external storage device through a network adapter card and/or network interface included in the network module 115.

Continuing, FIG. 2 depicts a computing environment 200 which may be an extension of the computing environment 100 of FIG. 1 operating as part of a network. In addition to the computing system 101, computing environment 200 may include a network 102 (e.g., a wide area network (WAN) or another type of computer network) connecting the computing system 101 to an end user device (EUD) 103, remote server 104, public cloud 105, and/or private cloud 106. In this embodiment, the computing system 101 includes a processor set 110 (including processing circuitry 120 and cache 121), communication fabric 111, volatile memory 112, persistent storage 113 (including operating system 122 and program(s) 150, as identified above), peripheral device set 114 (including user interface (UI), device set 123, storage 124, IoT sensor set 125, and network module 115. The remote server 104 may include a remote database 130. The public cloud 105 includes a gateway 140, cloud orchestration module 141, host physical machine set 142, virtual machine set 143, and/or container set 144.

The network 102 may be comprised of wired or wireless connections. For example, connections may be comprised of computer hardware such as copper transmission cables, optical transmission fibers, wireless transmission, routers, firewalls, switches, gateway computers and/or edge servers. The network 102 may be described as any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area (e.g., a Wi-Fi network). Other types of networks that may be used to interconnect various computer systems 101, end user devices 103, remote servers 104, private cloud 106, and/or public cloud 105 may include Wireless Local Area Networks (WLANs), home area network (HAN), backbone networks (BBN), peer-to-peer (P2P) networks, campus networks, enterprise networks, the Internet, single tenant or multi-tenant cloud computing networks, the Public Switched Telephone Network (PSTN), and/or any other network or network topology known by a person skilled in the art to interconnect computing systems 101.

The EUD 103 may include any computer device that can be used and/or controlled by an end user (e.g., a customer of an enterprise that operates a computing system 101), and it may take any of the forms discussed above in connection with the computing system 101. EUD 103 may receive helpful and useful data from the operations of computing system 101. For example, in a hypothetical case where the computing system 101 is designed to provide a recommendation to an end user, this recommendation may be communicated from network module 115 of computing system 101 through the WAN 102 to the EUD 103; in this example, the EUD 103 can display or otherwise present the recommendation to an end user. In some embodiments, the EUD 103 may be a client device (e.g., a thin client or a thick client) and/or a mobile computing device (e.g., a smart phone, mainframe computer, desktop computer, and so on).

The remote server 104 may be any computing system that serves at least some data and/or functionality to the computing system 101. The remote server 104 may be controlled and/or used by the same entity that operates the computing system 101. The remote server 104 represents the machine(s) that collect and/or store helpful and/or useful data for use by other computers such as the computing system 101. For example, in a hypothetical case where the computing system 101 is designed and programmed to provide a recommendation based on historical data, the historical data may be provided to the computing system 101 from the remote database 130 of the remote server 104.

The public cloud 105 may be any computing systems available for use by multiple entities that provide on-demand availability of computer system resources and/or other computer capabilities, such as data storage (cloud storage) and computing power, without direct active management by the user. The direct and active management of the computing resources of the public cloud 105 may be performed by computer hardware and/or software of cloud orchestration module 141. The computing resources provided by the public cloud 105 may be implemented by virtual computing environments that run on various computers making up the computers of host physical machine set 142 and/or the universe of physical computers in and/or available to public cloud 105. Virtual computing environments (VCEs) may take the form of virtual machines from virtual machine set 143 and/or containers from container set 144. It is understood that VCEs may be stored as images and/or may be transferred among and/or between the various physical machine hosts either as images and/or after instantiation of the VCE. The cloud orchestration module 141 may manage the transfer and/or storage of images, deploy new instantiations of VCEs, and manage active instantiations of VCE deployments. The gateway 140 is computer software, hardware, and/or firmware enabling the public cloud 105 to communicate through the network 102.

VCEs can be stored as images. A new active instance of the VCE can be instantiated from the image. Two types of VCEs may include virtual machines and containers. A container is a VCE that uses operating system-level virtualization in which the kernel allows the existence of multiple isolated user-space instances called containers. These isolated user-space instances may behave as physical computers from the point of view of the programs 150 running in them. An application 150 running on an operating system 122 may utilize all resources of that computer such as connected devices, files and folders, network shares, CPU power, and/or quantifiable hardware capabilities. Applications 150 running inside a container of container set 144 may only use the contents of the container and devices assigned to the container; this feature which may be referred to as containerization.

A private cloud 106 may be similar to public cloud 105 except that the computing resources may only be available for use by a single enterprise. While the private cloud 106 is depicted as being in communication with network 102 (e.g., the Internet), in some embodiments, a private cloud 106 may be disconnected from the internet entirely and only accessible through a local/private network. A hybrid cloud may refer to a composition of multiple clouds of different types (for example, private, community, and/or public cloud types), and the plurality of clouds may be implemented or operated by different vendors. Each of the multiple clouds remains a separate and discrete entity, but the larger hybrid cloud architecture is bound together by standardized and/or proprietary technology that enables orchestration, management, and/or data/application portability between the multiple constituent clouds. In this embodiment, public cloud 105 and private cloud 106 may be both part of a larger hybrid cloud environment.

Referring now to FIG. 3, a block diagram of an example system 300 for cold chain temperature control optimization in accordance with aspects of the present disclosure is illustrated.

As depicted, the system 300 includes shipment requests 302, a logistics planner 304, a thermal agent forecasting system 306, destinations 308, a shipment processor 310, and shipment metrics 312.

In some embodiments, for every shipment request of the shipment requests 302, the logistics planner 304 (which may be referred to as the cold chain logistics planner) may call the thermal agent forecasting system 306 to derive the optimal quantity of thermal agent required for each shipment associated with its respective shipment request of the shipment requests 302. In some embodiments, the thermal agent forecasting system 306 may be a cognitive thermal agent estimation and forecasting system (e.g., the thermal agent forecasting system 306 may utilize machine learning (ML) and artificial intelligence (AI) to optimize features of the system 300). In some embodiments, the logistics planner 304 may receive one or more shipment metrics 312 and send estimation inputs to the thermal agent forecasting system 306 based on the shipment metrics 312. The shipment metrics 312 may include, for example, package weight, dimension(s), shipping routes, transit times, temperature requirement, and the like.

In some embodiments, the system 300 may further derive a thermal agent quantity required for each segment, leg, or hop of a shipment and/or to any destination within the destinations 308. The system 300 utilizing the thermal agent forecasting system 306 may consider re-icing facilities in transit for thermal agent quantity required for each segment of the shipment to any of the destinations 308. Put another way, the system 300 may estimate the amount of thermal agent required to keep a package at a desired temperature between a first point (e.g., first destination, starting point, shipment facility, etc.) and next point (e.g., second destination, re-icing facility, end point, etc.) in a route. Likewise, the system 300, utilizing the shipment processor 310, may compute the quantity of thermal agent required to re-ice a package of a shipment from the shipment requests 302 from multiple (e.g., all) facilities (e.g., destinations 308) in the route of that shipment. In some embodiments, the system 300 may aggregate the cumulative quantities of thermal agents required at each of the destinations 308 (e.g., facilities) derived from various such shipment requests 302 and provide a facility/destination-level forecast for production and/or procurement of the thermal agent. The shipment processor 310 may use the forecast information as processed through thermal agent forecasting system 306 and destinations 308 to generate the required thermal agents as the packages move through the facilities at each of the destinations 308.

The shipment level estimation of thermal agents required may then be returned to the shipping processor 310. It is noted that inputs from the logistics planner 304 such as routes, estimated thermal agent quantity, and the like may flow to the shipment processor 310.

In the event of changes in a shipment plan as determined by the logistics planner 304 or shipment processor 310 (e.g., route changes due to a natural disaster, cancellation of shipments, etc.), the thermal agent forecasting system 310 may be called for re-estimation by passing the new inputs (e.g., how long the shipment/package is to rest at any of the destinations 308 before movement). In some embodiments, an estimation engine in the system 300 may recompute the thermal agent requirement and send the new estimation to the thermal agent forecast system 300 to be consumed by the re-icing facilities and/or destinations 308.

In some embodiments, an actual quantity of thermal agent used in a shipment may be different from an estimated one. For example, if the quantity was over-estimated, then there would be excess quantity left at the end of a hop to one or more of the destinations 308. If the quantity was under-estimated, then additional thermal agents might have been procured on-demand with higher cost. Accordingly, at the end of each shipment hop, the shipment processor 310 may capture any deviation between actual and estimated quantity and any reasons for deviation from the estimated value; this feedback may be used to help ensure better accuracy in thermal agent estimates on future shipments.

In some embodiments, error data (e.g., deviation value and the reason) may be fed back to the thermal agent forecasting system 306 to auto-calibrate an estimation model of the thermal agent forecasting system 306 for more accurate estimation in the future. In some embodiments, the estimation engine (not depicted) may employ back-propagation algorithms to correct the weightage for estimation parameters in order to minimize error (e.g., deviation).

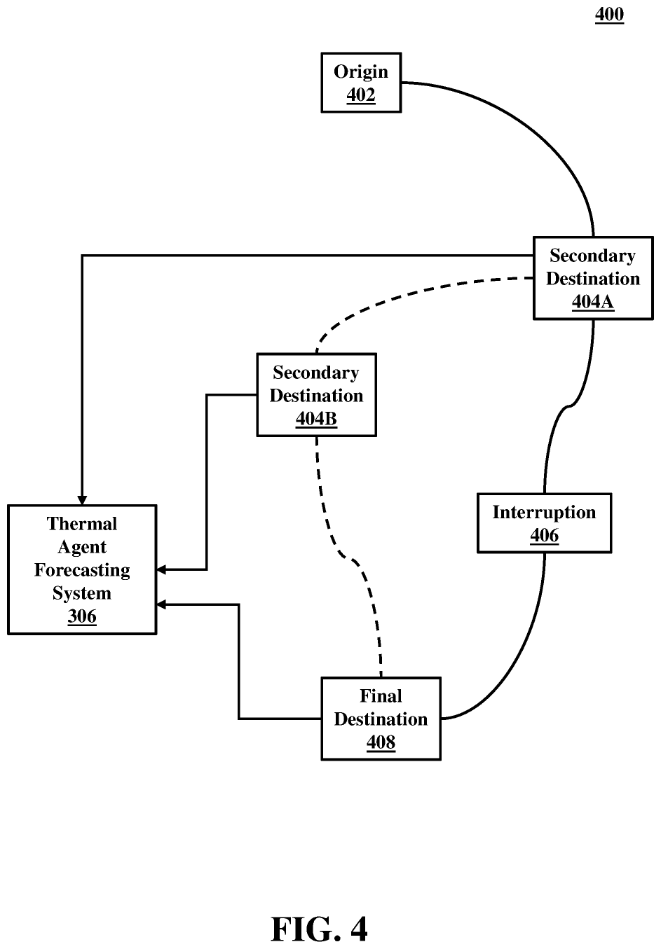

Referring to FIG. 4, a block diagram of an example implementation 400 of the example system 300 for cold chain temperature control optimization in accordance with aspects of the present disclosure is illustrated. As depicted, the implementation 400 includes the thermal agent forecasting system 306, an origin 402, a secondary destination 404A, a secondary destination 404B, an interruption 406, and a final destination 408.

As an example of the implementation 400, the proposed solution described herein may be applied in a cold chain system (e.g., the system 300) that carries a temperature-sensitive package (not depicted) from the origin 402 to the secondary destinations 404A-B and then to the final destination 408. In such an example, a logistics planner (e.g., logistics planner 304 of FIG. 3) of a logistics provider may call on the thermal agent forecasting system 306 to estimate and/or forecast the thermal agent (e.g., dry ice) quantities required to ship a particular package from the origin 402 to the final destination 408. The logistics planner may request a route via the secondary destinations 404A-B which may be intermediate facilities, interim points, and/or re-icing stops.

The thermal agent forecasting system 306 may compute the amount of thermal agent (e.g., dry ice) required at the origin 402 to ship the package to one or any of the secondary destinations 404A-B and the amount of re-icing to be done at one or more of the secondary destinations 404A-B to ship the package to the final destination 408 in accordance with identified temperature, humidity, and/or similar conditions.

In some embodiments, as the package moves from the origin 402, there may be an incident, referred to herein as an interruption 406, that may occur along the route between a secondary destination 404A and the final destination 408 causing the shipping process to reroute the package to another secondary destination 404B. In such an embodiment, the thermal agent forecasting system 306, in communication with a processor (e.g., shipment processor 310 of FIG. 3), may find the new route (e.g., reroute) for the package via the secondary destination 404B and call on the thermal agent forecasting system 306 to re-estimate and re-forecast the thermal agent (e.g., dry ice) quantities for the new route (e.g., as depicted by the dashed lines).

In some embodiments, the thermal agent forecasting system 306 may re-estimate the thermal agent (e.g., dry ice) quantities required at both secondary destinations 404A and 404B and re-forecast the thermal agent requirements at each facility associated with the secondary destinations 404A and 404B. Further, as the package completes each hop (from origin 402 to secondary destination 404A to secondary destination 404B to final destination 408, etc.), a processor (e.g., shipping processor 310 of FIG. 3) may compare the actual thermal agent (e.g., dry ice) used in that hop with the estimated quantity of thermal agent; if there is a deviation, an error-feedback may be sent back to the thermal agent forecast system 306 for auto-calibration. The processor (e.g., shipping processor 310 of FIG. 3) may communicate with and/or act through the thermal agent forecasting system 306 (which may be in communication with a planner, e.g., logistics planner 304 of FIG. 3) to perform a comparison and thus determine a deviation, if any.

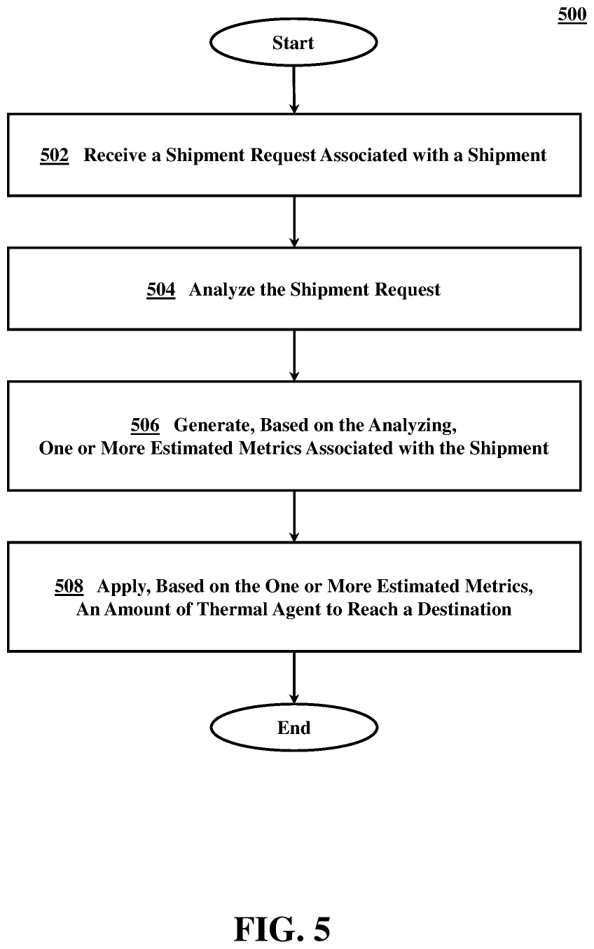

Referring now to FIG. 5, an example method 500 for cold chain temperature control optimization in accordance with aspects of the present disclosure is illustrated as a flowchart. In some embodiments, the method 500 may be performed by a processor (e.g., the shipment processor 310 of the system 300 in FIG. 3).

In some embodiments, the method 500 begins at operation 502, where the processor receives a shipment request associated with a shipment. In some embodiments, the method 500 proceeds to operation 504 where the processor analyzes the shipment request. In some embodiments, the method 500 proceeds to operation 506 where the processor generates, based on the analyzing, one or more estimated metrics associated with the shipment. In some embodiments, the method 500 proceeds to operation 508 where the processor may apply, based on the one or more estimated metrics, an amount of thermal agent for the shipment to reach a final destination. In some embodiments, after operation 508, the method 500 may end.

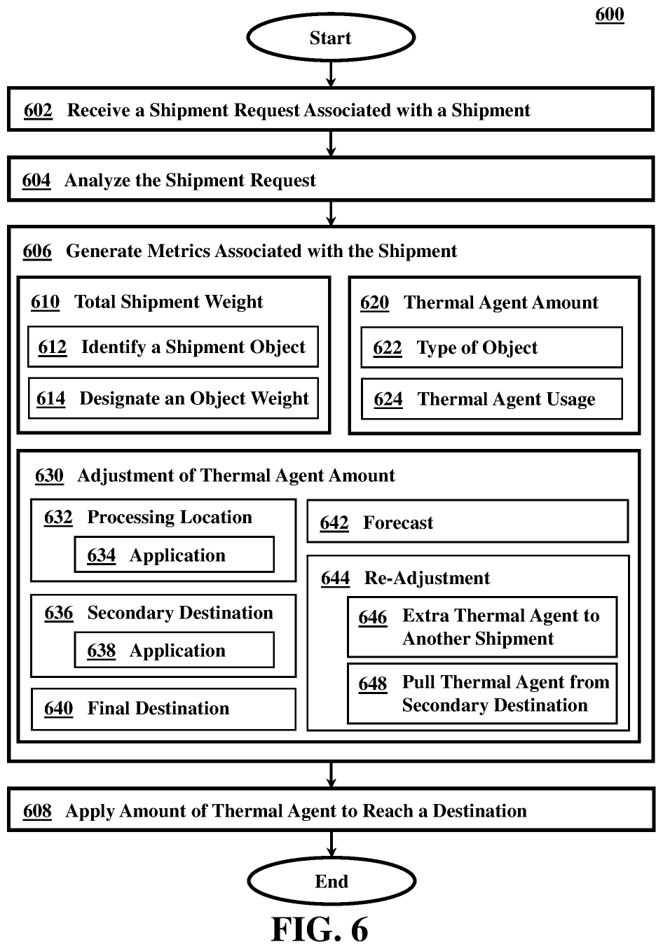

Referring now to FIG. 6, an example method 600 for cold chain temperature control optimization in accordance with aspects of the present disclosure is illustrated as a flowchart. In some embodiments, the method 600 may be performed by a processor (e.g., the shipment processor 310 of the system 300 in FIG. 3).

In some embodiments, the method 600 begins at operation 602, where the processor receives a shipment request associated with a shipment. In some embodiments, the method 600 proceeds to operation 604 where the processor analyzes the shipment request. In some embodiments, the method 600 proceeds to operation 606 where the processor generates metrics associated with the shipment. In some embodiments, the method 600 proceeds to operation 608 where the processor may apply an amount of thermal agent for the shipment to reach a final destination. In some embodiments, after operation 608, the method 600 may end.

In some embodiments of the present disclosure, operation 606 may include various sub-operations. As shown in FIG. 6, in operation 606, the processor generates metrics associated with the shipment, and generating these metrics may include operation 610 where the processor generates a total shipment weight, operation 620 where the processor generates the amount of the thermal agent, and/or operation 630 where the processor adjusts the amount of thermal agent.

In some embodiments, operation 610, where the processor generates a total shipment weight, may include operation 612 where the processor identifies one or more objects of the shipment. Operation 610 may further include operation 614 where the processor designates an object weight for each of the one or more objects of the shipment. The processor may use the object identity information from operation 612 and the object weight information from operation 614 to generate a total shipment weight at operation 610.

In some embodiments, operation 620, where the processor generates the amount of the thermal agent, may include operation 622 where the processor identifies a respective type of object for each of the one or more objects in the shipment. Operation 620 may further include operation 624 where the processor identifies respective thermal agent usages for each of the one or more objects of the shipment. The processor may use the type of object information from operation 622 and the thermal agent usage information from operation 624 to generate the amount of thermal agent at operation 620.

In some embodiments, operation 630, where the processor adjusts the amount of thermal agent, may include one or more considerations. Operation 630 may include identifying a final destination for the shipment according to the shipment request at operation 640. Operation 630 may include approximating one or more secondary destinations before the shipment reaches the final destination at operation 636. In some embodiments, operation 636 may include operation 368, that is, applying one or more secondary amounts of thermal agent at any of the one or more secondary locations.

In some embodiments, operation 630, where the processor adjusts the amount of thermal agent, may include identifying a first location processing the shipment at operation 632. Operation 632 may include operation 634, that is, applying a first amount of thermal agent at the first location processing the equipment.

In some embodiments, operation 630, where the processor adjusts the amount of thermal agent, may include receiving forecasting information associated with the final destination and/or the one or more secondary destinations at operation 642. Operation 630 may include adjusting the amount of thermal agent applied (e.g., at the first location processing or at a secondary destination) based on the forecasting information.

In some embodiments, operation 630, where the processor adjusts the amount of thermal agent, may include identifying that the amount of thermal agent could be optimized and thus re-adjusted at operation 644. In some embodiments, operation 644 may include identifying that the amount of thermal agent was over-adjusted and applying the over-adjustment to another shipment (e.g., a second shipment request) at operation 646. In some embodiments, operation 644 may include identifying that the amount of thermal agent was under-adjusted and pulling an amount of thermal agent equal to the under-adjustment from one of the one or more secondary locations (e.g., removing the identified amount of thermal agent from a secondary destination to apply to the shipment) at operation 648.

In some embodiments, the processor may adjust and/or re-adjust the amount of thermal agent for the shipment automatically. For example, the processor may determine at operation 620 that ten pounds of dry ice is necessary for the shipment request based on normal conditions; the processor may then receive a weather report (e.g., via a forecast at operation 642) showing that temperatures will be higher than normal during the shipment and that traffic is expected to be heavier than usual (e.g., via a forecast at operation 642) between the secondary destination and the final destination. In this example, the processor may automatically increase the amount of dry ice to be applied at the secondary destination, so the shipment arrives at the final destination at prescribed temperature and/or humidity conditions.

In some embodiments, one or more operations of method 500 and method 600 may not be depicted for the sake of brevity. These operations may be discussed throughout this disclosure, including as discussed below.

Accordingly, in some embodiments, generating the one or more estimated metrics may include the processor identifying, from the shipment request, one or more objects of the shipment. The processor may further designate respective object weights for each of the one or more objects of the shipment, and generate, from the respective object weights, a total shipment weight.

In some embodiments, the processor identifies a respective type of object for each of the one or more objects of the shipment, identifies respective thermal agent usages for each of the one or more objects of the shipment, and generates, from the respective thermal agent usages, the amount of thermal agent.

In some embodiments, the processor identifies, from shipment request, the final destination for the shipment, approximates that there are one or more secondary destinations before the shipment reaches the final destination, and adjusts, automatically, the amount of thermal agent based on the one or more secondary destinations.

In some embodiments, applying the amount of thermal agent for the shipment (e.g., package of the shipment) to reach the final destination includes the processor applying a first amount of thermal agent at a first location processing the shipment and applying one or more secondary amounts of thermal agent at any of the one or more secondary destinations.

In some embodiments, the processor receives forecasting information associated with the final destination and the one or more secondary destinations and adjusts, automatically, the amount of thermal agent.

In some embodiments, the processor identifies that the amount of thermal agent was over-adjusted, and applies the over-adjustment to a second shipment request (e.g., using the excess thermal agent for another shipment). In some embodiments, the processor identifies that the amount of thermal agent was under-adjusted and removes an amount of thermal agent equal to the under-adjustment from one of the one or more secondary destinations and/or adds more thermal agent at a secondary destination to reach the final destination.

It is noted that the descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer system for cold chain temperature control optimization, the computer system comprising:
one or more processors, one or more computer-readable memories, and one or more computer-readable storage media;
program instructions, stored on at least one of the one or more storage media for execution by at least one of the one or more processors via at least one of the one or more memories, to receive a shipment request associated with a shipment;
program instructions, stored on at least one of the one or more storage media for execution by at least one of the one or more processors via at least one of the one or more memories, to analyze the shipment request;
program instructions, stored on at least one of the one or more storage media for execution by at least one of the one or more processors via at least one of the one or more memories, to generate one or more estimated metrics associated with the shipment based on the analyzing; and
program instructions, stored on at least one of the one or more storage media for execution by at least one of the one or more processors via at least one of the one or more memories, to apply an amount of thermal agent for the shipment to reach a final destination based on the one or more estimated metrics.

2. The computer system of claim 1, wherein generating the one or more estimated metrics includes:
identifying one or more objects of the shipment from the shipment request;
designating respective object weights for each of the one or more objects of the shipment; and
generating a total shipment weight from the respective object weights.

3. The computer system of claim 2, further comprising:
program instructions, stored on at least one of the one or more storage media for execution by at least one of the one or more processors via at least one of the one or more memories, to identify a respective type of object for each of the one or more objects of the shipment;
program instructions, stored on at least one of the one or more storage media for execution by at least one of the one or more processors via at least one of the one or more memories, to identify respective thermal agent usages for each of the one or more objects of the shipment; and
program instructions, stored on at least one of the one or more storage media for execution by at least one of the one or more processors via at least one of the one or more memories, to generate the amount of thermal agent from the respective thermal agent usages.

4. The computer system of claim 3, further comprising:
program instructions, stored on at least one of the one or more storage media for execution by at least one of the one or more processors via at least one of the one or more memories, to identify the final destination for the shipment from shipment request;
program instructions, stored on at least one of the one or more storage media for execution by at least one of the one or more processors via at least one of the one or more memories, to approximate that there are one or more secondary destinations before the shipment reaches the final destination; and
program instructions, stored on at least one of the one or more storage media for execution by at least one of the one or more processors via at least one of the one or more memories, to adjust, automatically, the amount of thermal agent based on the one or more secondary destinations.

5. The computer system of claim 4, wherein applying the amount of thermal agent for the shipment to reach the final destination includes:
applying a first amount of thermal agent at a first location processing the shipment; and
applying one or more secondary amounts of thermal agent at any of the one or more secondary destinations.

6. The computer system of claim 5, further comprising:
program instructions, stored on at least one of the one or more storage media for execution by at least one of the one or more processors via at least one of the one or more memories, to receive forecasting information associated with the final destination and the one or more secondary destinations; and
program instructions, stored on at least one of the one or more storage media for execution by at least one of the one or more processors via at least one of the one or more memories, to adjust, automatically, the amount of thermal agent.

7. The computer system of claim 6, further comprising:
program instructions, stored on at least one of the one or more storage media for execution by at least one of the one or more processors via at least one of the one or more memories, to identify that the amount of thermal agent was over-adjusted; and
program instructions, stored on at least one of the one or more storage media for execution by at least one of the one or more processors via at least one of the one or more memories, to apply the over-adjustment to a second shipment request.

8. The computer system of claim 6, further comprising:
program instructions, stored on at least one of the one or more storage media for execution by at least one of the one or more processors via at least one of the one or more memories, to identify that the amount of thermal agent was under-adjusted; and
program instructions, stored on at least one of the one or more storage media for execution by at least one of the one or more processors via at least one of the one or more memories, to remove an amount of thermal agent equal to the under-adjustment from one of the one or more secondary destinations.

9. A computer-implemented method for cold chain temperature control optimization, the method comprising:
receiving, by a processor, a shipment request associated with a shipment;
analyzing the shipment request;
generating one or more estimated metrics associated with the shipment based on the analyzing; and
applying an amount of thermal agent for the shipment to reach a final destination based on the one or more estimated metrics.

10. The method of claim 9, wherein generating the one or more estimated metrics includes:
identifying one or more objects of the shipment from the shipment request;
designating respective object weights for each of the one or more objects of the shipment; and
generating a total shipment weight from the respective object weights.

11. The method of claim 10, further comprising:
identifying a respective type of object for each of the one or more objects of the shipment;
identifying respective thermal agent usages for each of the one or more objects of the shipment; and
generating the amount of thermal agent from the respective thermal agent usages.

12. The method of claim 11, further comprising:
identifying the final destination for the shipment from the shipment request;
approximating that there are one or more secondary destinations before the shipment reaches the final destination; and
adjusting, automatically, the amount of thermal agent based on the one or more secondary destinations.

13. The method of claim 12, wherein applying the amount of thermal agent for the shipment to reach the final destination includes:
applying a first amount of thermal agent at a first location processing the shipment; and
applying one or more secondary amounts of thermal agent at any of the one or more secondary destinations.

14. The method of claim 13, further comprising:
receiving forecasting information associated with the final destination and the one or more secondary destinations; and
adjusting, automatically, the amount of thermal agent.

15. The method of claim 14, further comprising:
identifying that the amount of thermal agent was over-adjusted; and
applying the over-adjustment to a second shipment request.

16. The method of claim 14, further comprising:
identifying that the amount of thermal agent was under-adjusted; and
removing an amount of thermal agent equal to the under-adjustment from one of the one or more secondary destinations.

17. A computer program product for cold chain temperature control optimization, the computer system comprising:
one or more computer-readable storage media;
program instructions, stored on at least one of the one or more storage media for execution by at least one of the one or more processors via at least one of the one or more memories, to receive a shipment request associated with a shipment;
program instructions, stored on at least one of the one or more storage media for execution by at least one of the one or more processors via at least one of the one or more memories, to analyze the shipment request;
program instructions, stored on at least one of the one or more storage media for execution by at least one of the one or more processors via at least one of the one or more memories, to generate one or more estimated metrics associated with the shipment based on the analyzing; and
program instructions, stored on at least one of the one or more storage media for execution by at least one of the one or more processors via at least one of the one or more memories, to apply an amount of thermal agent for the shipment to reach a final destination based on the one or more estimated metrics.

18. The computer program product of claim 17, wherein generating the one or more estimated metrics includes:
identifying one or more objects of the shipment from the shipment request;
designating respective object weights for each of the one or more objects of the shipment; and
generating a total shipment weight from the respective object weights.

19. The computer program product of claim 18, further comprising:
program instructions, stored on at least one of the one or more storage media for execution by at least one of the one or more processors via at least one of the one or more memories, to identify a respective type of object for each of the one or more objects of the shipment;
program instructions, stored on at least one of the one or more storage media for execution by at least one of the one or more processors via at least one of the one or more memories, to identify respective thermal agent usages for each of the one or more objects of the shipment; and
program instructions, stored on at least one of the one or more storage media for execution by at least one of the one or more processors via at least one of the one or more memories, to generate the amount of thermal agent from the respective thermal agent usages.

20. The computer program product of claim 19, further comprising:
program instructions, stored on at least one of the one or more storage media for execution by at least one of the one or more processors via at least one of the one or more memories, to identify the final destination for the shipment from shipment request;
program instructions, stored on at least one of the one or more storage media for execution by at least one of the one or more processors via at least one of the one or more memories, to approximate that there are one or more secondary destinations before the shipment reaches the final destination; and
program instructions, stored on at least one of the one or more storage media for execution by at least one of the one or more processors via at least one of the one or more memories, to adjust, automatically, the amount of thermal agent based on the one or more secondary destinations.
